(19) United States
(12) Patent Application Publication
(10) Pub. No.: US 2006/0014008 A1
(43) Pub. Date: Jan. 19, 2006

(54) Force dispersion pad

(75) Inventors: Daniel Printz Guyton, Akron, OH (US); Douglas McCullough Evans, Akron, OH (US)

Correspondence Address: Timothy D. Bennett;Brouse McDowell, LPA, Ste. 500, 106 S. Main Street, Akron, OH, 44308-1471, US

(73) Assignee: AKRON GENERAL MEDICAL CENTER

(21) Appl. No.: 10/891,663

(22) Filed: Jul. 15, 2004

(51) Int. Cl. B32B 3/26; B32B 15/04; B32B 7/12

(52) U.S. Cl. 428/304.4; 428/343

(57) ABSTRACT

A force dispersion pad includes multiple layers of foam and granules that disperse impact force. The pad includes an adhesive that is applied to the backing for placing the pad on a given surface. A backing material is included that covers the adhesive until it is ready to be used.

### BACKGROUND OF THE INVENTION

1. Field of Invention

This invention pertains to the art of methods and apparatus for protecting a person's body against injury and wear due to impacts by dispersing the force of such impacts, and more specifically to methods and apparatuses for dispersing forces which can include the affixing of a force dispersion device to a portion of the human body for protecting a person from injury due to impacts from outside forces or falling.

2. Brief History

It is known that padding for apparel has been made from foam or cloth materials. These have provided some degree of protection but improvements are desirable. Traditional commercially available pads are not adequate because they only reduce the impact force to twice the force required to break bones during a routine trip and fall. For elderly people whose bones are more brittle, those at the greatest risk, conventional commercially available pads only reduce the impact force to four times the force required to break bones such as the hip. Cushioning of articles for shipment has been provided by polystyrene foam wrapped in polyethylene film for encapsulating an article to be shipped. Another packaging device includes polystyrene beads glued to a polyethylene web material. However, none of these packaging inventions provides for the dispersion of impact force with a lightweight, disposable, hygienic pad which is provided by the construction of this invention.

The present invention contemplates new and improved protective pad that easily installs onto a given surface for protecting a person or object from injury or damage due to impacts. The invention is simple in design, effective in use, and overcomes the foregoing difficulties and others while providing better and more advantageous overall results.

### SUMMARY OF THE INVENTION

In accordance with the present invention, a new and improved force dispersion pad for protecting the wearer from injury due to impacts from outside forces or falling is provided which disperses the force of impact, thus preventing broken bones and other personal injury.

More particularly, in accordance with the present invention a protective article placed to protect a part of a person's body from injury due to impacts includes, a first layer of protective material, a second layer of protective material spaced a distance apart from the first layer, a third layer of protective material interposed between the first layer and the second layer wherein the third layer is made of granules. An adhesive is applied to the article for use in securing the protective article in a position adjacent the part of the person's body subject to injury from impact.

According to one aspect of the invention, a method of making a protective cushioned article includes the steps of forming a cushion package by positioning a layer of polystyrene granules between two sheets of polyethylene, containing the cushion package in a pocket member, and placing the pocket member in an enclosure in the article.

According to another aspect of the present invention a protective pad is provided which includes a first layer of protective material, a second layer of protective material spaced a distance apart from the first layer, and a third layer of protective material interposed between the first layer and the second layer. The third layer is made of granules.

One advantage of the present invention is its capability to disperse enough impact force to protect bones, particularly the hip, from being broken in a fall or as a result of an impact.

Another advantage of the present invention is the applicability of the pad to be placed anywhere where adhesive backing may be used.

Another advantage of the present invention is its applicability to be applied to sports equipment such as football helmets, as well as flooring, chairs, beds, tables and the like.

Another advantage of the present invention is that it is lightweight, limiting its burden to the wearer, particularly the elderly.

Another advantage of the present invention is that it is inexpensive, making it disposable.

Another advantage of the present invention is its applicability to extend the time the impact force is applied and dispersed.

Still other benefits and advantages of the invention will become apparent to those skilled in the art to which it pertains upon a reading and understanding of the following detailed specification.

### BRIEF DESCRIPTION OF THE DRAWINGS

FIG. 1 is a perspective view of a pad according to the invention with parts being broken away.

FIG. 2 is a graph of impact force as a function of time for the pad of FIG. 1.

FIG. 3 is a perspective view of a preferred embodiment of the pad of the present invention showing the adhesive and backing.

FIG. 4 is a perspective view of the pad of the present invention placed on a portion of the body.

### DESCRIPTION OF THE PREFERRED EMBODIMENT

Referring now to the drawings wherein the showings are for purposes of illustrating a preferred embodiment of the invention only and not for purposes of limiting the same, the FIGURES shows a perspective, cross-sectional view of a protective pad 10. The pad 10 has a layer of granules 16 sandwiched between two sheets 20, 22, respectively.

Preferably, the granules 16 are made of foamed polystyrene. The polystyrene granules 16 are preferably round or substantially round in shape, and have a diameter between 1.0 mm and 10.0 mm, and preferably between 2.0 mm and 3.0 mm. While polystyrene is the preferred material for the granules 16, other materials exhibiting lightweight and force dispersing characteristics may also be employed.

Preferably, the sheets 20, 22 are made of foamed polyethylene. The polyethylene sheets 20, 22 are between 0.5 mm and 5.0 mm thick, preferably 1.0 mm thick. Polyethylene is the preferred material for the sheets 20, 22, however, any suitable material may be utilized.

The pad 10 is effective to reduce the force of an impact to the body of the wearer of the pad 10, such as may occur through a fall to a floor. The pad 10 extends the time over which the impact occurs, thereby allowing additional time to disperse impact forces. This impact time extension of the pad 10 is achieved by the pad 10 forming a buffer between the body and the floor, or some other object creating the impact. The extension of time of impact allows the pad 10 to disperse much of the force of impact, reducing the amount of stress placed upon fragile body parts such as hips, particularly in the elderly.

The pad 10 disperses force by transferring the force to the many surfaces of the granules 16 found in the pad 10. Also, the two sheets 20, 22 act as baffles that absorb a portion of the force. As the force of the impact is transferred along the many granular surfaces, displacing them relative to each other, the force is dispersed over a greater area throughout the pad 10. The greater the number of small particulate interfaces employed, the greater the dispersion of force. This dispersion is effective to protect areas of a person's body susceptible to injury. In one embodiment, baffles 120, 122 may be included within the space between the two sheets 20, 22 to increase the effect of baffles. However, it is noted that baffles 120, 122 are not required but may be optionally included in any manner chosen with sound engineering judgment.

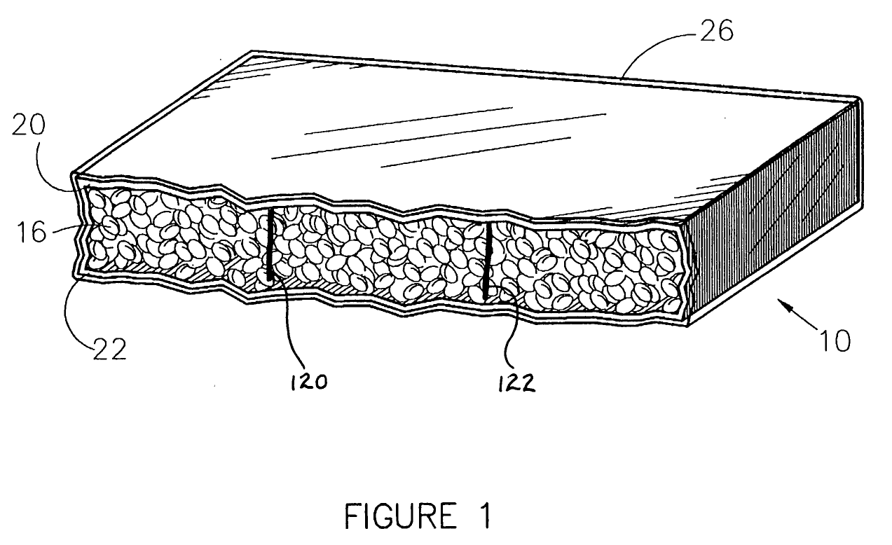

With continuing reference to FIG. 1, in the preferred embodiment, the pad 10 preferably has an outer retaining member 26, such as a thin layer of plastic or any other suitable material, designed to hold the layers of the pad 10 together upon impact.

A typical fall may produce an impact force of up to 6500 newtons on the hip, more than enough to break the hip if the force is directed at the hip. Use of the protective pad 10 can disperse the force and lower the amount of force directed at the hip to about 840 newtons. This level is below a minimum fracture threshold of 1000 newtons, thus preventing hip fracture.

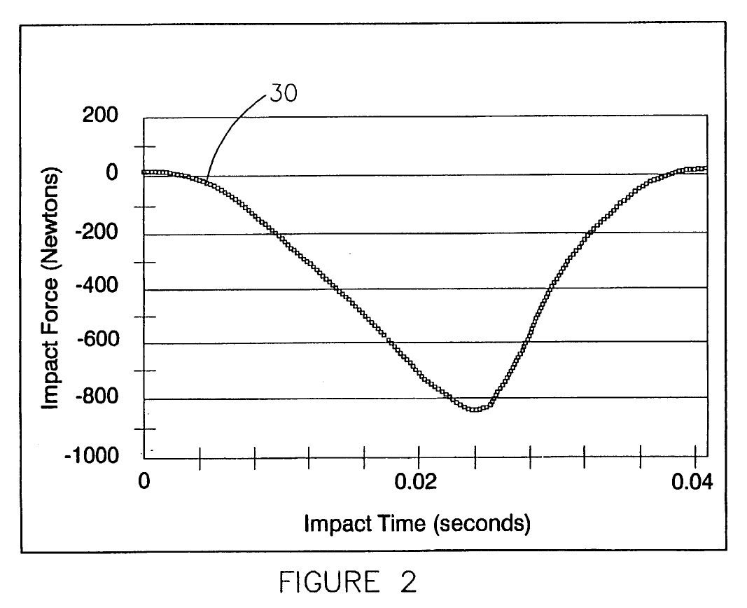

FIG. 2 shows a graph of the dispersed impact force 30 at the protected area expressed in newtons as a function of time into impact, expressed in seconds. As illustrated, as the time into impact increases up to 0.02 seconds, the dispersed impact force 30 increases to the maximum level of 840 newtons, which is below the force which may fracture a hip bone. The dispersion of force over a period of time reduces the maximum force directed at the hip at any one moment.

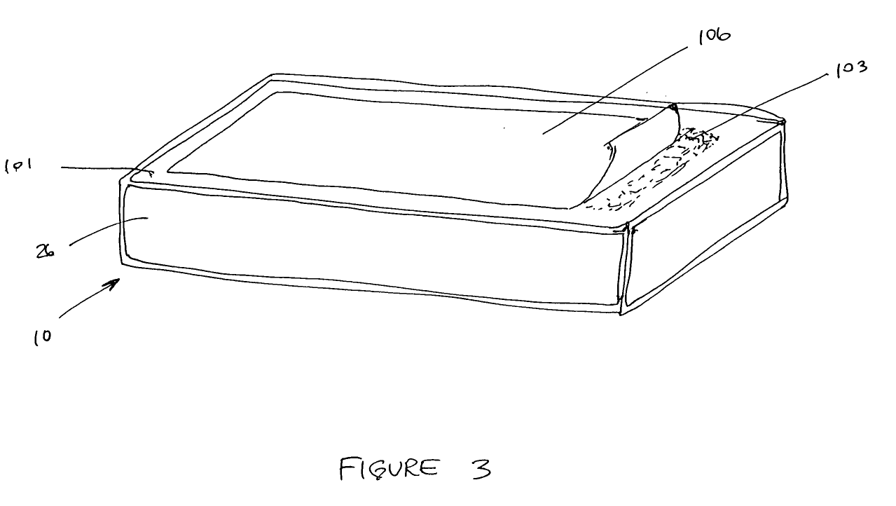

FIG. 3 shows one embodiment of an application of the present invention. The pad 10 may have an outer surface 101. More specifically, the outer retaining member 26 may have an outer surface 101. In this embodiment, an adhesive 103 may be applied to the outer surface 101 in a specific region. That is to say that the adhesive 103 may be only applied to a limited area of the outer retaining member 26. Subsequently, an adhesive backing 106 may be placed over the adhesive 103. In this way, the adhesive 103 retains its properties to stick to an abutted objected until use of the pad is desired. A user of the pad 10 needs only to remove the adhesive backing 106 to expose the adhesive 103 and apply the pad 10 to an area of the body that needs to be protected from impact forces. It is noted that the type of adhesive 103 may be any adhesive chosen for the application at hand. For example, if the adhesive is to be adhered to plastic, such as inside a bicycle helmet, then an adhesive with those properties should be chosen. Likewise, adhesive that is to adhere to clothing and adhesive that is gentle for use on human skin could each be chosen in accordance with sound engineering judgment. Moreover, the adhesive 103 may be such that it is conducive for use of the skin of the elderly, which may be more sensitive than that of a young adult. However, any type of adhesive 103 may be used as chosen with sound medical and engineering practices.

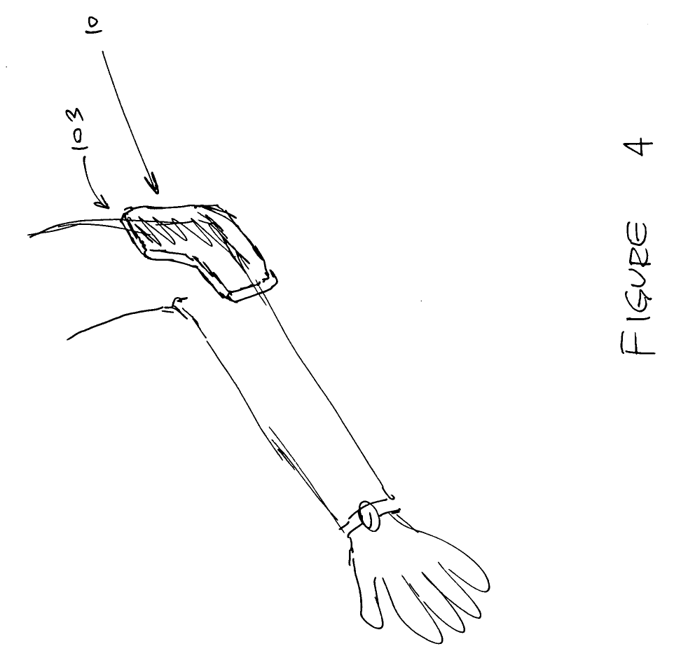

Referencing FIG. 4, to disperse the force of impact of a fall, the protective pad 10 may be positioned over the portion of the body that requires protection from impact force. The pad 10 may be grasped in one hand by the user. Subsequently, the user may peel off the backing 106 and apply the pad as desired. The adhesive 103 would then hold the pad 10 in place during use. In this way, the pad 10 may be applied directly to the skin of the person utilizing the pad 10. For example, the pad 10 may be placed over the greater trochanter or other region to receive and disperse impact forces.

The pad 10 has been discussed with reference to one of its primary intended purposes, namely, use by elderly people to avoid hip fractures. However, the protective padding 10 has other uses. The padding 10 may also be used in protective equipment such as that used in sports. Particularly, the pad 10 may be used in sporting helmets to reduce the force of impacts to the head of the wearer, such as in bicycle helmets and football helmets. With the adhesive backing, the pad 10 may be installed and removed as needed. The pad 10 may also be used in football pads, baseball chest protectors, knee and elbow pads, and to protect horseback riders. Also, the pad 10 may be applied to goal posts, backboards, ice rink walls, and anywhere else where a collision is likely to take place. Additionally, the pad 10 may be incorporated in automobiles to help reduce and disperse the impact of automobile collisions. For example, the pad 10 may be incorporated into padding to be used in the doors, ceilings, dashboards, seats, and child safety seats. The pad may be used as a cushion to stand on, for workers in factories or cashiers that need to be on their feet for long periods of time. The pad 10 may be incorporated into padding for medical applications in such areas to reduce pressure sores on elbows and heels, as well as in hygienic operating table mattress pads.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

It is now claimed:

1. A force dispersion device, comprising:
a flexible outer retaining member forming an enclosure, the outer retaining member having at least a first outer surface portion;
a plurality of granules for use in dispersing an associated impact force, wherein the granules are contained entirely within the flexible outer retaining member; and,
an adhesive applied to the at least a first outer surface portion of the outer retaining member.

2. The force dispersion device of claim 1, further comprising:
a removable adhesive backing member affixed to cover the adhesive.

3. The force dispersion device of claim 2, further comprising:
first and second sheets of foamed plastic, wherein the first sheet of foamed plastic is spaced apart from the second sheet of foamed plastic, and,
wherein the plurality of granules are positioned between the first and second sheets of foamed plastic.

4. The force dispersion device of claim 3, wherein at least some of said granules are loose.

5. The force dispersion device of claim 4, the first layer of foamed plastic is comprised of polyethylene.

6. The force dispersion device of claim 5, the granules are made of foamed plastic.

7. The force dispersion device of claim 6, the foamed plastic granules are made of polystyrene.

8. The force dispersion device of claim 7, the first layer has a thickness between 0.5 mm and 5.0 mm.

9. The force dispersion device of claim 8, the granules have a diameter between 1.0 mm and 10.0 mm.

10. A method of protecting a portion of a human with a force dispersion device, the steps comprising:
providing a force dispersion device including:
a first sheet of foamed plastic;
a second sheet of foamed plastic spaced apart from the first sheet of foamed plastic;
a layer of granules disposed between the first and second sheets of foamed plastic;
a flexible outer retaining member having at least a first outer surface portion, the outer retaining member forming an enclosure around the first and second sheets of foamed and the layer of granules;
an adhesive applied to the at least a first outer surface portion of the outer retaining member; and,
an adhesive backing member removably connected to cover the adhesive;
removing the adhesive backing member; and,
affixing the force dispersion device to predetermined area of the human body.
